(19) United States
(12) Patent Application Publication
(10) Pub. No.: US 2014/0272495 A1
(43) Pub. Date: Sep. 18, 2014

(54) BATTERY SYSTEM WITH COOLED ELECTRICAL CONNECTORS

(71) Applicant: ENERDEL, INC., Greenfield, IN (US)

(72) Inventors: Bruce James Silk, Indianapolis, IN (US); Derrick Scott Buck, Pendleton, IN (US)

(73) Assignee: ENERDEL, INC., Greenfield, IN (US)

(21) Appl. No.: 13/828,171

(22) Filed: Mar. 14, 2013

(51) Int. Cl. H01M 10/50; H01M 10/04

(52) U.S. Cl. CPC H01M 10/5004; H01M 10/04
USPC 429/72; 29/623.1

(57) ABSTRACT

A multi-cell battery system is disclosed including a plurality of battery sub-assemblies stacked together along a longitudinal axis, and an electrical connector between the battery sub-assemblies. A heat exchange passageway passes across the electrical connector to cool the battery system. An exemplary electrical connector includes a plurality of heat transfer features to promote cooling of the battery system.

### FIELD OF THE DISCLOSURE

The present disclosure relates to a battery system. More particularly, the present disclosure relates to a cooling system and method for a multi-cell battery system.

### BACKGROUND OF THE DISCLOSURE

A plurality of battery cells, such as lithium-ion battery cells, may be stacked together to form a multi-cell battery system. In U.S. Patent Application Publication No. 2012/0021271 to Tople et al., for example, a battery system is disclosed with a stacked arrangement of battery cells and frames.

In operation, such battery systems may generate heat, especially during repeated charging and discharging of the battery system. A cooling system may be provided to remove heat from the battery system. However, the thermal path of the cooling system may be relatively long and indirect.

The present disclosure provides a battery system with a more direct thermal path for improved cooling.

### SUMMARY

The present disclosure provides a multi-cell battery system that includes a plurality of battery sub-assemblies stacked together along a longitudinal axis, and an electrical connector between the battery sub-assemblies. A heat exchange passageway passes across the electrical connector to cool the battery system. An exemplary electrical connector includes a plurality of heat transfer features to promote cooling of the battery system.

According to an embodiment of the present disclosure, a battery system is provided having a longitudinal axis, the battery system including a plurality of prismatic battery cells including a first cell having a first terminal extending from the first cell, and a second cell having a second terminal extending from the second cell, the second cell arranged longitudinally of the first cell along the longitudinal axis, an electrical connector that electrically couples the first terminal of the first cell to the second terminal of the second cell, and a heat exchange passageway across the electrical connector.

According to another embodiment of the present disclosure, a battery system is provided including a first framed sub-assembly including a first plurality of prismatic battery cells, each of the first plurality of prismatic battery cells having a terminal, a second framed sub-assembly removably coupled to the first framed sub-assembly and including a second plurality of prismatic battery cells, each of the second plurality of prismatic battery cells having a terminal, and an electrical connector that electrically couples the first plurality of prismatic battery cells to the second plurality of prismatic battery cells, and a heat exchange passageway across the electrical connector.

According to yet another embodiment of the present disclosure, a method is provided for assembling a battery system. The battery system includes a longitudinal axis and a plurality of prismatic battery cells including a first cell and a second cell. The method includes the steps of arranging the second cell longitudinally of the first cell along the longitudinal axis, electrically coupling a first terminal of the first cell to a second terminal of the second cell with an electrical connector, and passing a heat exchange medium across the electrical connector to cool the first cell and the second cell.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a perspective view of an exemplary battery system of the present disclosure, the battery system including a plurality of battery sub-assemblies;

FIG. 2 is an elevational view of the battery system of FIG. 1, also including a detailed elevational view of a heat exchange passageway of the battery system;

FIG. 3 is a perspective view of the battery system of FIG. 1 shown with a cover removed from an exterior side of the battery system to expose a plurality of electrical connectors between the battery sub-assemblies;

FIG. 4 is an exploded perspective view of a battery sub-assembly of FIG. 1;

FIG. 5 is a perspective view of the electrical connector of FIG. 3;

FIG. 6 is a perspective view of another exemplary electrical connector of the present disclosure;

FIG. 7 is a perspective view of yet another exemplary electrical connector of the present disclosure; and

FIG. 8 is an exploded perspective view of the cover and the electrical connectors of FIGS. 1-3.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

An exemplary multi-cell battery system 10 is shown in FIGS. 1-3. Battery system 10 may include a plurality of secondary (rechargeable) or non-rechargeable battery cells, as discussed further below. Battery system 10 may be used in a hybrid vehicle or an electric vehicle (e.g., a car, a bus), for example, serving as a power source that drives an electric motor of the vehicle. Battery system 10 may also store and provide energy to other devices which receive power from batteries, such as the stationary energy storage market. Exemplary applications for the stationary energy storage market include providing power to a power grid, providing power as an uninterrupted power supply, and other loads which may utilize a stationary power source. In one embodiment, battery system 10 may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

The illustrative battery system 10 of FIGS. 1-3 includes a first end support 12, a second end support 14 opposite the first end support 12, and at least one battery sub-assembly 16 positioned between the first and second end supports 12, 14. Battery system 10 also includes a positive terminal 18P and a negative terminal 18N for charging and discharging battery system 10. Battery system 10 further includes at least one support 20 that holds first and second end supports 12, 14 and battery sub-assemblies 16 together. Individual components of the battery system 10 are described further below with continued reference to FIGS. 1-3.

First and second end supports 12, 14, of battery system 10 are arranged at opposite ends of the battery system 10 to protect and hold together the battery sub-assemblies 16 positioned therebetween. First and second end supports 12, 14, are illustratively rectangular in shape, although the shape may vary. First and second end supports 12, 14, may be constructed of plastic or another suitable non-conductive material. Although not illustrated in FIGS. 1-3, each end support 12, 14, may include a mounting structure for mounting the battery system 10 in place. If, for example, the battery system 10 will be used to power a vehicle, each end support 12, 14, may include one or more rails (not shown) or other suitable mounting brackets for mounting the battery system 10 to the chassis of the vehicle.

Battery sub-assemblies 16 of battery system 10 are stacked together along a longitudinal axis L of battery system 10. Each battery sub-assembly 16 is generally rectangular in shape, although the shape may vary. Each individual battery sub-assembly 16 (i.e., the plane containing each individual battery sub-assembly 16) is oriented in a direction generally perpendicular to the longitudinal axis L, as shown in FIG. 1, with adjacent battery sub-assemblies 16 being oriented generally parallel to one another. The number of battery sub-assemblies 16 in the battery system 10 may vary depending on the desired application.

Supports 20 of battery system 10 illustratively include internal tie rods. First and second end supports 12, 14, and battery sub-assemblies 16 cooperate to define internal channels 22 (FIG. 4) for receiving tie rods 20 through battery system 10. As shown in FIG. 1, tie rods 20 are located in each corner of battery system 10 and extend generally parallel to longitudinal axis L of battery system 10. When nuts 24 are tightened onto the threaded ends of each tie rod 20, battery sub-assemblies 16 may become compressed together between the first and second end supports 12, 14. Other suitable supports include external bands, for example, that are wrapped and secured around battery system 10. Foam sheets (not shown) may be sandwiched between adjacent components of battery system 10 to cushion and stabilize the compressed battery system 10.

An individual battery sub-assembly 16 of battery system 10 is shown in more detail in FIG. 4. Each battery sub-assembly 16 illustratively includes a first frame 30 (i.e., an upper frame in FIG. 4) and a second frame 32 (i.e., a lower frame in FIG. 4). First and second frames 30, 32, are illustratively rectangular and planar in shape and hollow in the middle, although this shape may vary. For example, first and second frames 30, 32, may be solid in construction without being hollow in the middle. First and second frames 30, 32, may be constructed of plastic or another suitable non-conductive material.

When assembled, first frame 30 cooperates with second frame 32 to receive one or more battery cells therebetween, illustratively a first battery cell 34 (i.e., an upper battery cell in FIG. 4) and a second battery cell 36 (i.e., a lower battery cell in FIG. 4). In this arrangement, battery cells 34, 36, are sandwiched together between corresponding first and second frames 30, 32. The battery sub-assembly 16 of FIG. 4 includes two battery cells 34, 36, but this number may vary. As shown in FIG. 4, each generally rectangular frame 30, 32 (i.e., the plane containing each individual frame 30, 32) and each generally rectangular battery cell 34, 36 (i.e., the plane containing each individual battery cell 34, 36) is oriented in a direction generally perpendicular to the longitudinal axis L. In certain embodiments, foam strips (not shown) or other suitable spacers may be positioned between battery cells 34, 36 of each battery sub-assembly 16.

Each battery sub-assembly 16 may optionally include a framed heat sink assembly 38 between first and second battery cells 34, 36. In this embodiment, first and second frames 30, 32, may be indirectly coupled together via the framed heat sink assembly 38, with each frame 30, 32, being coupled to an opposing side of the framed heat sink assembly 38. In other embodiments, the framed heat sink assembly 38 is not included between first and second battery cells 34, 36. In these embodiments, first and second frames 30, 32, may be directly coupled together. First and second frames 30, 32, and the optional framed heat sink assembly 38, if included, may be snapped, screwed, welded, adhered, or otherwise coupled together. In the illustrated embodiment of FIG. 4, snap arms 39 extend from both sides of the framed heat sink assembly 38 around the periphery of the framed heat sink assembly 38 to engage first and second frames 30, 32.

Each individual battery sub-assembly 16 may be pre-assembled around battery cells 34, 36, before being distributed commercially. In this manner, each battery sub-assembly 16 may form an independent, self-contained, modular unit of battery system 10. The pre-assembled nature of each battery sub-assembly 16 may facilitate the transportation, storage, and purchasing of individual battery sub-assemblies 16 and the subsequent assembly of battery system 10. For example, a customer may order battery sub-assemblies 16, store the battery sub-assemblies 16, and then assemble a desired number of the battery sub-assemblies 16 in a desired arrangement to produce a custom battery system 10 having a desired voltage and capacity. The pre-assembled nature of each battery sub-assembly 16 may also protect battery cells 34, 36, from damage caused by the environment or human tampering, for example. The customer may also disassemble battery system 10 and remove and replace an individual battery sub-assembly 16, if necessary.

Exemplary battery cells 34, 36, for use in battery system 10 include prismatic, lithium-ion cells, for example. Battery cells 34, 36, are illustratively rectangular and planar in shape, although this shape may vary. Each battery cell 34, 36, may include a plurality of anodes and cathodes stacked together with an electrolyte inside an insulating envelope or package 40. Package 40 may be constructed of a polymer-coated aluminum foil or another suitable material, for example. Each package 40 of FIG. 4 illustratively includes an inner body portion 42, an outer sealed portion 44 surrounding the inner body portion 42, a first generally planar surface 46 (i.e., an upper surface in FIG. 4), and a second generally planar surface 48 (i.e., a lower surface in FIG. 4) opposing the first surface 46. First and second frames 30, 32, and framed heat sink assembly 38, if included, may clamp onto the outer sealed portion 44 of battery cells 34, 36, in a manner that surrounds and frames the inner body portion 42 of battery cells 34, 36. If first and second frames 30, 32, are hollow in the middle, as shown in FIG. 4, the inner body portion 42 of each battery cell 34, 36, may be visible. By contrast, if first and second frames 30, 32, are solid in construction, the inner body portion 42 of each battery cell 34, 36, may be covered.

Each battery cell 34, 36, further includes a positive terminal 50P and a negative terminal 50N that communicate electrically with the electrical components inside of package 40. In FIG. 4, positive and negative terminals 50P, 50N, extend from opposite sides of package 40, but it is also within the scope of the present disclosure that positive and negative terminals 50P, 50N, may extend from the same side of package 40. Also in FIG. 4, positive and negative terminals 50P, 50N, are bent by 90 degrees relative to battery cells 34, 36, to form positive and negative coupling surfaces 54P, 54N (not shown), respectively. A pair of openings 58P, 58N (not shown), is defined in the coupling surface 54P, 54N, of each terminal 50P, 50N, respectively. Negative terminals 50N are not entirely visible in FIG. 4, but negative coupling surfaces 54N of negative terminals 50N would be similar to positive coupling surfaces 54P of the opposing positive terminals 50P, and openings 58N in negative terminals 50N would be similar to openings 58P in the opposing positive terminals 50P.

To aid in the proper assembly of each battery sub-assembly 16 and adjacent battery sub-assemblies 16, the distance between openings 58P may differ from the distance between openings 58N (not shown), as described in U.S. Patent Application Publication No. 2012/0231318 to Buck et al., the disclosure of which is expressly incorporated herein by reference in its entirety. For example, openings 58P in each positive terminal 50P may be spaced relatively far apart, while openings 58N (not shown) in each negative terminal 50N may be spaced relatively close together.

Battery cells 34, 36, of each battery sub-assembly 16 and/or adjacent battery sub-assemblies 16 may be electrically connected in parallel or series. In the illustrated embodiment, battery cells 34, 36, of each battery sub-assembly 16 are electrically connected in parallel, and adjacent battery sub-assemblies 16 are electrically connected in series. This electrical arrangement may be achieved by rotating select battery sub-assemblies 16 (e.g., every other battery sub-assembly 16) by 180 degrees around the longitudinal axis L relative to the other battery sub-assemblies 16. However, the electrical arrangement of each battery sub-assembly 16 and/or adjacent battery sub-assemblies 16 may vary to produce a battery system 10 having a desired voltage and capacity. Ultimately, battery sub-assemblies 16 may be electrically coupled to positive and negative terminals 18P, 18N to charge and discharge battery system 10.

In the illustrated embodiment of FIG. 4, the parallel electrical connection between battery cells 34, 36, is achieved by physically overlapping and mechanically clamping together corresponding positive terminals 50P of battery cells 34, 36, and corresponding negative terminals 50N of battery cells 34, 36, with suitable electrical connectors 70. In FIG. 4, the overlap occurs between positive coupling surfaces 54P of corresponding positive terminals 50P and between negative coupling surfaces 54N (not shown) of corresponding negative terminals 50N. Electrical connectors 70 may be constructed of a thermally and electrically conductive material. A first pair of threaded studs 62P is provided to receive each electrical connector 70 over the overlapping positive terminals 50P, and a second pair of threaded studs 62N (FIG. 3) is provided to receive each electrical connector 70 over the overlapping negative terminals 50N. Nuts 64 are also provided to secure electrical connectors 70 onto studs 62P, 62N. Each electrical connector 70 may have a crowned or bowed configuration to apply a uniform pressure to the underlying terminals 50P, 50N. Studs 62P, 62N, illustratively extend from the framed heat sink assembly 38, but it is also within the scope of the present disclosure that studs 62P, 62N, may extend from first frame 30 and/or second frame 32, especially if the framed heat sink assembly 38 is not included.

When coupling surfaces 54P, 54N, of terminals 50P, 50N, overlap, openings 58P, 58N, in terminals 50P, 50N, also overlap. Studs 62P, 62N, are sized, shaped, and spaced to extend through these overlapping openings 58P, 58N. Because the distance between openings 58P may differ from the distance between openings 58N, the distance between studs 62P may similarly differ from the distance between studs 62N. For example, as shown in FIG. 3, studs 62P may be spaced relatively far apart for receipt through openings 58P, while studs 62N may be spaced relatively close together for receipt through openings 58N.

In the illustrated embodiment of FIG. 3, the series electrical connection between adjacent battery sub-assemblies 16 is also achieved with electrical connectors 70, specifically bus bars or jumper tabs, between adjacent battery sub-assemblies 16. Each electrical connector 70 may be sized and shaped to span across studs 62P, 62N, of one, two, or more adjacent battery sub-assemblies 16. The illustrative electrical connector 70 of FIGS. 3 and 4 is configured to electrically connect two adjacent battery sub-assemblies 16a, 16b, so the illustrative electrical connector 70 includes a base portion 74 with two sets of holes—a first set of holes 72P that receive a first set of studs 62P from a first battery sub-assembly 16a, and a second set of holes 72N that receive a second set of studs 62N from a second battery sub-assembly 16b. Because the distance between studs 62P may differ from the distance between studs 62N, the distance between holes 72P may similarly differ from the distance between holes 72N. For example, as shown in FIG. 3, holes 72P may be spaced relatively far apart to receive studs 62P, while holes 72N may be spaced relatively close together to receive studs 62N. It is also within the scope of the present disclosure that electrical connector 70 may be configured to connect three or more adjacent battery sub-assemblies 16, so the number and arrangement of holes in electrical connector 70 may vary. When assembled, as shown in FIGS. 3 and 4, nuts 64 may tighten base portion 74 of electrical connector 70 against the underlying terminals 50P, 50N, on an outer side of battery system 10.

Returning to FIG. 4, each optional framed heat sink assembly 38, if included, may have a thermally conductive plate 90 (e.g., aluminum, copper), a frame 92 surrounding plate 90 to mechanically interact with first and second frames 30, 32, and a thermal interface portion 94 that projects outwardly from first and second frames 30, 32. In the illustrated embodiment of FIG. 4, the thermal interface portion 94 includes a plurality of fins 96 that cooperate to define a generally rectangular passageway or conduit 98 therebetween, although the shape and configuration of the thermal interface portion 94 may vary.

In use, a heat exchange medium (e.g., air, water) flows through conduit 98. Heat from battery cells 34, 36, may travel through the walls of each package 40, into and through conductive plate 90, and to the thermal interface portion 94 to be carried away by the heat exchange medium in conduit 98 by convection. In the illustrated embodiment of FIG. 4, conduit 98 receives the heat exchange medium in the direction of arrow C. As shown in FIGS. 1 and 3, the direction C is transverse, and more specifically perpendicular, to the longitudinal axis L of battery system 10. Also, the direction C is parallel to each of the first and second end supports 12, 14, the battery sub-assemblies 16, and the battery cells 34, 36, contained therein.

In addition to, or instead of, achieving cooling through the optional framed heat sink assemblies 38, battery system 10 of the present disclosure may achieve more direct cooling through electrical connectors 70. An exemplary electrical connector 70 is shown in more detail in FIG. 5. The illustrative electrical connector 70 includes a plate-shaped base portion 74 that communicates with the underlying terminals 50P, 50N (FIG. 4). The illustrative electrical connector 70 also includes a thermal interface portion 76 on the side opposite from terminals 50P, 50N (FIG. 4) with a plurality of heat transfer features that increase the surface area of base portion 74 for improved heat exchange. In the illustrated embodiment of FIG. 5, the heat transfer features of the thermal interface portion 76 include a plurality of generally rectangular, parallel fins 78 that extend from base portion 74 to increase the surface area of base portion 74. Tips 79 of fins 78 are illustratively rounded or curved in FIG. 5. The shape, arrangement, and number of fins 78 on electrical connector 70 may vary.

According to an exemplary embodiment of the present disclosure, the thermal interface portion 76 accommodates the passage of a heat exchange medium (e.g., air) across electrical connector 70 in at least one direction. In the illustrated embodiment of FIG. 5, fins 78 cooperate to define a plurality of parallel passageways or conduits 80 therebetween that receive the heat exchange medium in the direction of arrow A.

In use, the heat exchange medium flows through conduits 80 between fins 78 to remove heat from electrical connector 70 by convection. Because terminals 50P, 50N, may extend through openings in the walls of each package 40 to communicate with the components inside of package 40, heat from battery cells 34, 36, may reach terminals 50P, 50N, without having to travel through the walls of packages 40. In fact, heat from the electrical components inside of package 40 may concentrate along terminals 50P, 50N. From terminals 50P, 50N, heat may travel into electrical connector 70 and to the thermal interface portion 76 of electrical connector 70 to be carried away by the heat exchange medium in conduits 80. In this manner, removing heat via terminals 50P, 50N, may facilitate more direct and efficient cooling of battery cells 34, 36. Electricity may follow a similar pathway from terminals 50P, 50N, to electrical connector 70, so electrical connector 70 may be considered both thermally and electrically “hot”.

Another exemplary electrical connector 70′ is shown in FIG. 6. The heat transfer features of the thermal interface portion 76′ of electrical connector 70′ include a plurality of generally cylindrical posts or protrusions 82′ that are spaced apart to define conduits 80′ therebetween. Protrusions 82′ project from base portion 74′ to increase the surface area of base portion 74′. The shape, arrangement, and number of protrusions 82′ on electrical connector 70′ may vary. For example, rather than being shaped as generally cylindrical posts, protrusions 82′ may be shaped as hemispherical bumps, rectangular posts, or conical posts. In use, the heat exchange medium may flow around protrusions 82′ and through conduits 80′.

Yet another exemplary electrical connector 70″ is shown in FIG. 7. The heat transfer features of the thermal interface portion 76″ of electrical connector 70″ include a plurality of generally hemispherical dimples or indentations 84″ in base portion 74″ that increase the surface area of base portion 74″. The shape, arrangement, and number of indentations 84″ on electrical connector 70″ may vary. For example, rather than being shaped as generally hemispherical dimples, indentations 84″ may be rectangular, cylindrical, or conical in shape.

Returning to FIGS. 1 and 2, one or more covers 100 may be provided over electrical connectors 70 of battery system 10. In the illustrated embodiment of FIG. 2, two covers 100 are provided, one on each side of battery system 10, to cover electrical connectors 70 on both sides of battery system 10. Cover 100 may be constructed of an electrically insulating material (e.g., plastic) to insulate, shield, and protect the electrically conductive electrical connectors 70 beneath cover 100.

In addition to insulating electrical connectors 70, each cover 100 may form a passageway or conduit 102 that directs the heat exchange medium across electrical connectors 70 to facilitate cooling of electrical connectors 70 by convection. In one embodiment, ambient air may be allowed to freely enter and exit conduit 102. In another embodiment, air may be directed or forced through conduit 102. For example, a cool heat exchange medium may be directed into inlet 104 of conduit 102 from an inlet duct (not shown), and a warm heat exchange medium may be directed out of outlet 106 of conduit 102 through an outlet duct (not shown).

In the illustrated embodiment of FIGS. 1 and 3, the heat exchange medium travels through conduit 102 in the direction of arrow B to remove heat from electrical connectors 70 by convection. The direction B is illustratively parallel to the longitudinal axis L of battery system 10. Also, the direction B is illustratively transverse, and more specifically perpendicular, to the first and second end supports 12, 14, the battery sub-assemblies 16, and the battery cells 34, 36, contained therein. The direction B is also illustratively transverse, and more specifically perpendicular, to the direction C through conduits 98 of the optional framed heat sink assemblies 38.

To encourage the heat exchange medium to travel through conduit 102, the heat exchange medium may be pushed and/or pulled through conduit 102 by a suitable fan or pump, for example. Also, the inlet duct (not shown) that is coupled to inlet 104 of conduit 102 may converge or narrow as it moves toward cover 100, while the outlet duct (not shown) that is coupled to outlet 106 of conduit 102 may diverge or widen as it moves away from cover 100.

According to an exemplary embodiment of the present disclosure, the direction B through cover 100 (FIG. 1) is arranged to match the direction A across electrical connectors 70 (FIG. 5) to facilitate passage of the heat exchange medium through cover 100 and electrical connectors 70. In this arrangement, as the heat exchange medium is directed through conduit 102 in cover 100 in the direction B, the heat exchange medium also travels through conduits 80 of electrical connector 70 in the direction A, as shown in FIG. 3.

According to another exemplary embodiment of the present disclosure, cover 100 cooperates with electrical connectors 70 to encourage the heat exchange medium inside conduit 102 to interact with electrical connectors 70, not avoid electrical connectors 70. In the illustrated embodiment of FIG. 2, for example, cover 100 mates with fins 78 of electrical connectors 70, specifically the rounded tips 79 of fins 78. The mating arrangement shown in FIG. 2 minimizes free space in conduit 102 away from electrical connectors 70, thereby encouraging the heat exchange medium to travel through conduits 80 of electrical connectors 70. The heat exchange medium will take the path of least resistance through conduit 102. If cover 100 were spaced apart from electrical connectors 70, unlike FIG. 2, the heat exchange medium could avoid electrical connectors 70 by traveling over electrical connectors 70 in the free space between cover 100 and electrical connectors 70, for example. Also, the mating arrangement shown in FIG. 2 leaves most of the surface area of electrical connectors 70 exposed for heat exchange. Except for the small portion of the rounded tips 79 of fins 78 that contact cover 100, electrical connectors 70 remain exposed for heat exchange with the heat exchange medium inside conduit 102.

In addition to insulating electrical connectors 70 and providing a heat exchange pathway across electrical connectors 70, cover 100 may include one or more separators 108 that separate adjacent electrical connectors 70, as shown in FIG. 8. When battery sub-assemblies 16 are longitudinally compressed together by end supports 12, 14, and/or external forces, separators 108 may prevent contact between adjacent electrical connectors 70. As a result, separators 108 may prevent electrical shorts in battery system 10. In the heat exchange direction A, B, separators 108 may mimic the size and shape of electrical connectors 70. For example, as shown in FIG. 8, each separator 108 includes fins 110 that mimic and align with fins 78 of the adjacent electrical connectors 70 and conduits 112 that mimic and align with conduits 80 of the adjacent electrical connectors 70. In this manner, fins 110 of separator 108 may prevent contact between fins 78 of adjacent electrical connectors 70 to avoid electrical shorts, and conduits 112 of separator 108 may communicate with conduits 80 of adjacent electrical connectors 70 to facilitate passage of the heat exchange medium in direction A, B.

Temperature sensors (e.g., thermistors) may be provided throughout battery system 10 to control the flow of the heat exchange medium and to regulate the cooling of battery system 10. In one embodiment, the thermistors are positioned within one or more of the heat exchange conduits 80, 98, 102.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A battery system having a longitudinal axis, the battery system comprising:
a plurality of prismatic battery cells including:
a first cell having a first terminal extending from the first cell; and
a second cell having a second terminal extending from the second cell, the second cell arranged longitudinally of the first cell along the longitudinal axis;
an electrical connector that electrically couples the first terminal of the first cell to the second terminal of the second cell; and
a heat exchange passageway across the electrical connector.

2. The battery system of claim 1, wherein the heat exchange passageway is oriented parallel to the longitudinal axis.

3. The battery system of claim 1, wherein the heat exchange passageway is oriented transverse to the first and second cells.

4. The battery system of claim 3, wherein the heat exchange passageway is oriented perpendicular to the first and second cells.

5. The battery system of claim 1, further comprising an insulating cover coupled to the battery system, wherein the insulating cover forms at least a portion of the heat exchange passageway across the electrical connector.

6. The battery system of claim 1, wherein the electrical connector includes a plurality of heat transfer features.

7. The battery system of claim 6, wherein the electrical connector includes a base portion that electrically couples the first terminal of the first cell to the second terminal of the second cell, the plurality of heat transfer features increasing the surface area of the base portion.

8. The battery system of claim 6, wherein the plurality of heat transfer features includes a plurality of protrusions or indentations on the electrical connector.

9. The battery system of claim 8, wherein the heat exchange passageway is at least partially defined between the plurality of protrusions on the electrical connector.

10. The battery system of claim 8, wherein the plurality of protrusions are arranged in parallel to one another.

11. The battery system of claim 1, further comprising:
a third cell having a third terminal extending from the third cell, the first and third cells arranged together in a first framed sub-assembly with the first terminal of the first cell contacting the third terminal of the third cell;
a fourth cell having a fourth terminal extending from the fourth cell, the second and fourth cells arranged together in a second framed sub-assembly with the second terminal of the second cell contacting the fourth terminal of the fourth cell; and
wherein the electrical connector electrically couples the first and third terminals of the first framed sub-assembly to the second and fourth terminals of the second framed sub-assembly.

12. The battery system of claim 11, further comprising:
a first framed heat sink assembly between the first and third cells of the first framed sub-assembly; and
a second framed heat sink assembly between the second and fourth cells of the second framed sub-assembly.

13. The battery system of claim 12, wherein another heat exchange passageway extends across the first and second framed heat sink assemblies in a direction perpendicular to the heat exchange passageway across the electrical connector.

14. A battery system comprising:
a first framed sub-assembly including a first plurality of prismatic battery cells, each of the first plurality of prismatic battery cells having a terminal;
a second framed sub-assembly removably coupled to the first framed sub-assembly and including a second plurality of prismatic battery cells, each of the second plurality of prismatic battery cells having a terminal;
an electrical connector that electrically couples the first plurality of prismatic battery cells to the second plurality of prismatic battery cells; and
a heat exchange passageway across the electrical connector.

15. The battery system of claim 14, wherein the electrical connector includes a plurality of heat transfer features.

16. The battery system of claim 15, wherein the plurality of heat transfer features includes a plurality of fins that extend from the electrical connector.

17. The battery system of claim 16, wherein the heat exchange passageway is at least partially formed between the plurality of fins.

18. The battery system of claim 16, further comprising a cover over the electrical connector, the cover cooperating with the plurality of fins of the electrical connector to define the heat exchange passageway.

19. The battery system of claim 14, further comprising a cover over the electrical connector, the cover including a separator that separates the electrical connector from an adjacent electrical connector.

20. A method of assembling a battery system, the battery system including a longitudinal axis and a plurality of prismatic battery cells including a first cell and a second cell, the method comprising the steps of:
arranging the second cell longitudinally of the first cell along the longitudinal axis;
electrically coupling a first terminal of the first cell to a second terminal of the second cell with an electrical connector; and
passing a heat exchange medium across the electrical connector to cool the first cell and the second cell.

21. The method of claim 20, wherein the electrical connector includes a plurality of fins that cooperate to define a conduit, wherein the passing step comprises passing the heat exchange medium through the conduit between the plurality of fins.

22. The method of claim 20, wherein the passing step comprises passing the heat exchange medium in a direction parallel to the longitudinal axis.

23. The method of claim 20, wherein the passing step comprises passing the heat exchange medium in a direction perpendicular to the first and second cells.

24. The method of claim 20, wherein the passing step comprises passing air across the electrical connector.

25. The method of claim 20, further comprising the step of compressing the first and second cells together along the longitudinal axis.

26. The method of claim 20, wherein the electrical connector is located on an exterior side of the battery system.
